(19) United States
(12) Patent Application Publication
(10) Pub. No.: US 2024/0308476 A1
(43) Pub. Date: Sep. 19, 2024

(54) Wiper Blade with Fluid Reservoir

(71) Applicant: Illinois Tool Works Inc., Glenview, IL (US)

(72) Inventor: Martin William Rosas, Cypress, TX (US)

(21) Appl. No.: 18/590,252

(22) Filed: Feb. 28, 2024

Related U.S. Application Data
(60) Provisional application No. 63/452,575, filed on Mar. 16, 2023.

(51) Int. Cl. B60S 1/52; B60S 1/38; B60S 1/50

(52) U.S. Cl. CPC B60S 1/524; B60S 1/381; B60S 1/50

(57) ABSTRACT

Described is a wiper blade for a windshield of a vehicle. The wiper blade having a spoiler, a squeegee, and a plurality of dispensing ports. The squeegee is coupled to the spoiler and includes a wiping lip. The spoiler having a reservoir configured to hold a chemical solution. The plurality of dispensing ports are distributed along a length of the wiper blade, such as its spoiler. The plurality of dispensing ports is fluidly coupled to the reservoir to dispense the chemical solution onto a surface of a windshield. The plurality of dispensing ports can be positioned on each side of the wiping lip. The chemical solution can include at least one of a wax, a non-stick coating, and/or a water repellant.

### RELATED APPLICATION

The present application claims priority to U.S. Provisional Patent Application No. 63/452,575, filed Mar. 16, 2023, and entitled “Wiper Blade With Fluid Reservoir,” which is hereby incorporated by reference in its entirety.

### BACKGROUND

Windshield wipers are used to remove rain, snow, ice, washer fluid, water, and/or other debris from a vehicle's front or rear windshield. Almost all vehicles are equipped with one or more windshield wipers, including cars, trucks, buses, train locomotives, watercraft (e.g., those with a cabin) and even some aircraft. In many jurisdictions, windshield wipers are a legal requirement.

Vehicles use a variety of wiper blade types and configurations, but a common objective for all wiper blade types is that they conform to the surface and/or contour of the glass upon which they are mounted (whether a front or rear windshield) to effectively clear the windshield. In order to improve visibility in conditions, for example, it is often desired to increase the water repellency of an automobile windshield. A more water-repellant surface causes water to form beads with a high contact angle, and thus allows water droplets to be more easily and completely removed from the surface by action of the wiper blade.

Various techniques are known for increasing the water-repellency of glass surfaces. These include compositions such as those disclosed in U.S. Pat. No. 7,344,783, which discloses the use of a water repellent composition comprising a curing agent and a silicone resin that is preferably a silsesquioxane silicone resin. The current coating technologies can be inadequate because of their limited durability. Over time, for example, such coatings can wear off of the windshield due to the effects of, inter alia, jet blast and windshield wipers.

To address this, a coating can be reapplied by the consumer. Most chemical solutions applied to the windshield come from a bottled product and is applied by hand. Another example involves the use of applying a chemical solution to coat the wiper blade with a chemical coating product. The latter solution allows for the chemical solution to be transferred from the wiper blade to the windshield. Unfortunately, such wiper blades are currently a one-time application process because, once the chemical solution coated on the wiper blade is consumed, it can no longer reapply that chemical to the windshield.

Despite advancements to date, a need exists for an improved wiper blade and wiper blade system that can effectively reapply a chemical solution to a windshield.

### SUMMARY

The present disclosure relates generally to improved wiper blade, substantially as illustrated by and described in connection with at least one of the figures, as set forth more completely in the claims. More specifically, the present disclosure relates to an improved wiper blade and wiper blade system that can effectively reapply a chemical solution to a windshield.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an example vehicle having a windshield and a pair of wiper blades.

FIG. 1b illustrates an assembly view of an example connection point between the wiper blade and the wiper arm.

FIGS. 2a and 2b illustrate perspective side and cross-sectional views of a wiper blade in accordance with an aspect of the present disclosure.

FIGS. 3a through 3c illustrate a wiper blade in accordance with another aspect of the present disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Wiper blades used in vehicles vary in size and shape. In some cases, wiper blades can be the same shape, but will vary in size. While wiper blades are most often associated with automobiles (e.g., cars, trucks, etc.), they are likewise employed in numerous other vehicles, such as trains, watercraft, and aircraft. Therefore, the following disclosure should not be limited to wiper blades and wiper arms used in automobiles, but rather would be applicable to wiper blades and wiper arms used in any type of vehicle.

The present disclosure relates to an improved wiper blade and wiper blade system that can effectively reapply a chemical solution to a windshield. In one example, a wiper blade for a windshield of a vehicle comprises as spoiler, a squeegee coupled to the spoiler, and a plurality of dispensing ports distributed along a length of the wiper blade. The spoiler comprises a reservoir configured to hold a chemical solution. The squeegee comprises a wiping lip. The plurality of dispensing ports is fluidly coupled to the reservoir and configured to dispense the chemical solution onto a surface of the windshield.

Each of the plurality of dispensing ports may comprise a valve configured to control a release of the chemical solution therethrough. The valve is a pressure valve, a weighted valve, a check valve, etc. In some examples, the valve is controlled as a function of a position of the wiping lip as the wiper blade translates across the windshield in a first direction and a second direction that is opposite that of the first direction. In some examples, the valve is open while in the first direction and is closed while in the second direction.

In some examples, the spoiler further comprises one or more filler ports fluidly coupled to the reservoir. The spoiler can be removably coupled to the squeegee. In another example, the reservoir is fluidly coupled to a windshield washer system of the vehicle. In some examples, the chemical solution is a wax, a non-stick coating, a water repellant, etc.

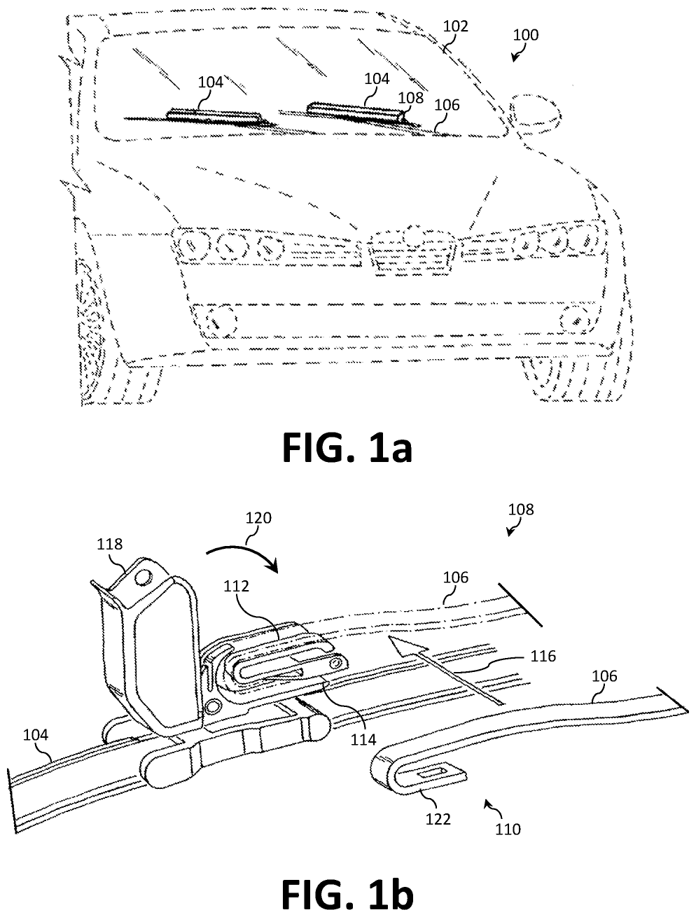

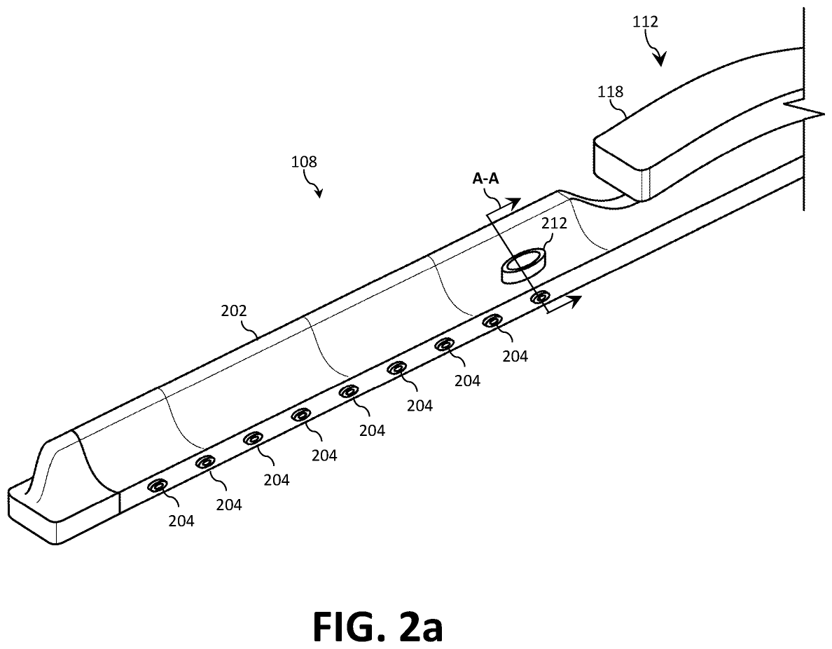

FIG. 1a illustrates an example vehicle 100 having a windshield 102 and a pair of wiper blades 104. As illustrated, each wiper blade 104 is removably coupled to a wiper arm 106 of the vehicle 100 via a coupling 108. As is known in the art, the wiper arms 106 (and, therefore, the wiper blades 104) are configured to translate back and forth across the windshield 102 to clear the windshield 102 of rain, snow, and debris via one or more electric motors and mechanical linkages associated with the vehicle 100.

FIG. 1b illustrates an assembly view of an example coupling 108 between the wiper blade 104 and the wiper arm 106. As illustrated, each wiper arm 106 includes or otherwise defines, at its distal end, an arm-side connector 110. The arm-side connector 110 is configured to engage and secure the wiper blade 104 via a complimentary blade-side connector 112 positioned on or otherwise associated with the wiper blade 104. In the illustrated example, the arm-side connector 110 is inserted into a J-shaped slot 114 of the blade-side connector 112 as indicated by arrow 116. Once assembled, a locking cap 118 can be folded as indicated by arrow 120 (e.g., pivoted about a hinge) and positioned to cover, secure, and protect the connected arm-side connector 110 and blade-side connector 112. In the illustrated example, the wiper arm 106 includes an arm-side connector 110 configured a J-Hook connector 122, but other connector types are contemplated.

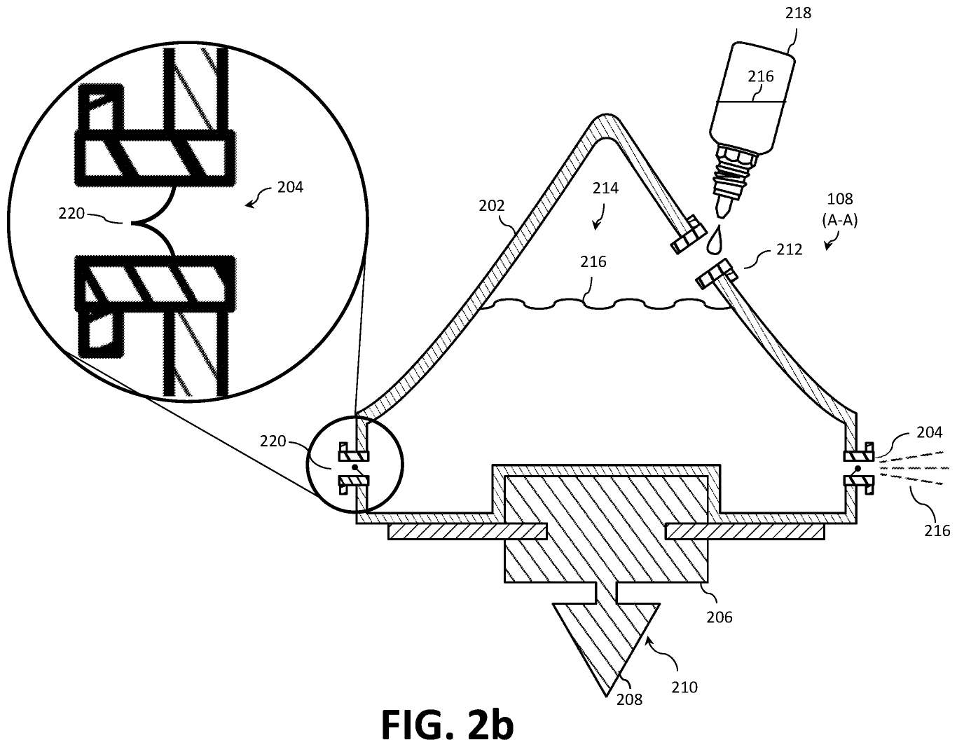

FIGS. 2a and 2b illustrate perspective side and cross-sectional views of a wiper blade 104 in accordance with an aspect of the present disclosure. Specifically, FIG. 2b illustrate a cross-sectional view of the wiper blade 104 taken along cut line A-A. The wiper blade 104 generally comprises a spoiler 202, a squeegee 206, and a wiping lip 208. The spoiler 202 is configured to couple to the wiper arm 106 via the blade-side connector 112 of the coupling 108. The blade-side connector 112 may be integral with the spoiler 202 or attached thereto via one or more fasteners, adhesives, etc.

As illustrated, the wiper blade 104 comprises an embedded manifold system to dispense a chemical solution 216 onto windshield 102 or other components of the wiper blade 104 (e.g., the wiping lip 208) in a metered of regulated fashion via a plurality of dispensing ports 204. Therefore, unlike existing one-time-use coated wiper blades, the wiper blade 104 comprises an embedded manifold system having a reservoir 214 that can be refilled with a chemical solution 216 via, for example, a bottle 218 to prolong the useful life of the wiper blade 104. The chemical solution 216 may comprise one or more chemical formulations to aid in debris, liquid, and streak removal efficacy, such as water repellants, waxes, soaps, formulations to improve the overall performance and/or longevity of the wiper blade, etc. While a bottle 218 is illustrated, in some examples the reservoir 214 itself may be replaced with a new full version. For example, the spoiler 202 can be provided as a replaceable consumable that, once the reservoir 214 is empty, can be replaced with a spoiler 202 having a new full reservoir 214.

In the illustrated example, the spoiler 202 is at least partially hollow and shaped to define or otherwise contain the reservoir 214 or other components of the manifold system. The reservoir 214 is configured to house the chemical solution 216. The volume of the reservoir 214 is dictated (or limited) by the length and the cross sectional area of the spoiler 202. The length of the spoiler 202 will depend on the vehicle 100 as the length of a wiper blade 104 (and thus the size of the reservoir 214 and the quantity of dispensing ports 204) will vary depending on the type of vehicle 100.

The spoiler 202 comprises or defines the plurality of dispensing ports 204 through which the chemical solution 216 can be dispensed onto the windshield 102 or other components of the wiper blade 104. To that end, the plurality of dispensing ports 204 is distributed along a length of the spoiler 202 and fluidly coupled to the reservoir 214. As illustrated, the proposed wiper blade 104 comprises a plurality of dispensing ports 204 distributed along the length of the spoiler 202 to dispense the chemical solution 216 in a substantially even fashion. The plurality of dispensing ports 204 can be positioned and distributed on each side of the spoiler 202. In another example, the plurality of dispensing ports 204 can distributed along the length of another component of the wiper blade 104, such as the squeegee 206 or a frame structure.

The dispensing ports 204 can be molded into the spoiler 202 (e.g., during manufacture thereof) or cut or drilled into the spoiler 202 (e.g., after manufacture thereof, whether mechanically or via a laser). In the illustrated example, the dispensing ports 204 are provided in the form of generally circular ports. While illustrated as generally circular ports, other shapes are contemplated for the dispensing ports 204 including, for example, slits and slots. Similarly, the plurality of dispensing ports 204 is illustrated as being arranged in the side wall 210 in a linear pattern (e.g., a row), but other patterns are contemplated, such as a grid pattern.

The windshield wiper blade 104 and components thereof (e.g., the spoiler 202, the squeegee 206, and/or wiping lip 208) can be fabricated from one or more elastomeric materials. Example elastomeric materials include, for example, thermoplastic polyurethane (TPU), thermoplastic vulcanizates (TPV), thermoplastic elastomers (TPE), flexible polyurethane (FPU), silicon, etc. In some examples, two or more components of the wiper blade 104 can be formed from the same material and/or as a single, integrated component. For example, the squeegee 206 and the wiping lip 208 could be fabricated as a single component. In some examples, a coating may be applied over the wiping lip 208 to mitigate the effects of the environment, such as debris. An example coating may include a non-stick or hydrophobic coating that mitigates the effects of debris and liquid by easily brushing the debris and liquid away from the wiping lip 208.

In some examples, the windshield wiper blade 104 (or a portion thereof) can be a printed plastic material component (e.g., thermoplastic, TPU, FPU, etc.). Printed plastic material components can be printed with great accuracy and with numerous details, which is particularly advantageous, for example, in creating components requiring complex and/or precise features. In addition, additive manufacturing techniques obviate the need for mold tooling, thereby lowering up-front manufacturing costs, which is particularly advantageous in low-volume productions. In some examples, the wiper blade 104 may be fabricated using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

While illustrated as an internal reservoir 214, additionally or alternatively, an external reservoir (e.g., one that is external to the wiper blade 104/spoiler 202) can be used. In one example, the reservoir 214 may be integrated, or fluidly coupled, with the vehicle 100, such as the washer fluid system of the vehicle 100. Using an external reservoir enables storage of a large volume of chemical solution 216 that would otherwise be prohibited due to the size constraints imposed by the size of the spoiler 202. In applications where the reservoir 214 is connected to the windshield washer system of the vehicle 100, the chemical solution 216 may be mixed into the washer fluid prior to dispensing through the dispensing ports.

The wiper blade 104 allows for a chemical solution 216 to be stored within the wiper blade 104 and applied slowly to the windshield 102 over time as the wiper blade 104 is used. To dispense the chemical solution 216 in a metered of regulated fashion, the wiper blade 104 further comprises a valve 220 to control (e.g., meter or otherwise regulate) the release of the chemical solution 216. The valve 220 may be fluidly coupled to or integrated with each of the plurality of dispensing ports 204. In one example, the valve 220 is a check valve designed to allow the chemical solution 216 to flow out of the reservoir 214 and prevent flow of liquid into the reservoir 214. Other example valves 220 include, for example, weighted valves, pressure valves, etc.

During operation, the back and forth motion of the wiper blade 104 can cause the valves 220 to open and close as the chemical solution 216 sloshes back and forth within the reservoir 214. That is, the movement of the wiper blade 104 and chemical solution 216 contained therein cause the pressure against the valve 220 to achieve a cracking pressure that forces a stopper off of the seat (e.g., as is the case with a ball check valve), thus opening the valve 220. Once the stopper off of the seat, the chemical solution 216 is permitted to exit the reservoir 214 through the dispensing port 204 and onto the windshield 102 or otherwise (e.g., on to the squeegee 206).

While a valve 220 is described, additionally or alternatively, a wicking material can be used pass or otherwise convey the chemical solution 216 from the reservoir 214, through an opening (whether a dispensing port 204 or otherwise) in a wall of the spoiler 202, and onto the windshield 102. The wicking material operates using the principles of capillary action to move the chemical solution 216 through the wicking material.

Once the chemical solution 216 is consumed, the fluid reservoir 214 can be replenished, allowing for continued application of the chemical solution 216 using the same wiper blade 104. To that end, the reservoir 214 will have one or more access filler ports 212, which would allow for the reservoir 214 to be replenished with chemical solution 216 after consumption. To mitigated evaporation and spillage, the access filler ports 212 can include a lid or cap, such as a threaded cap.

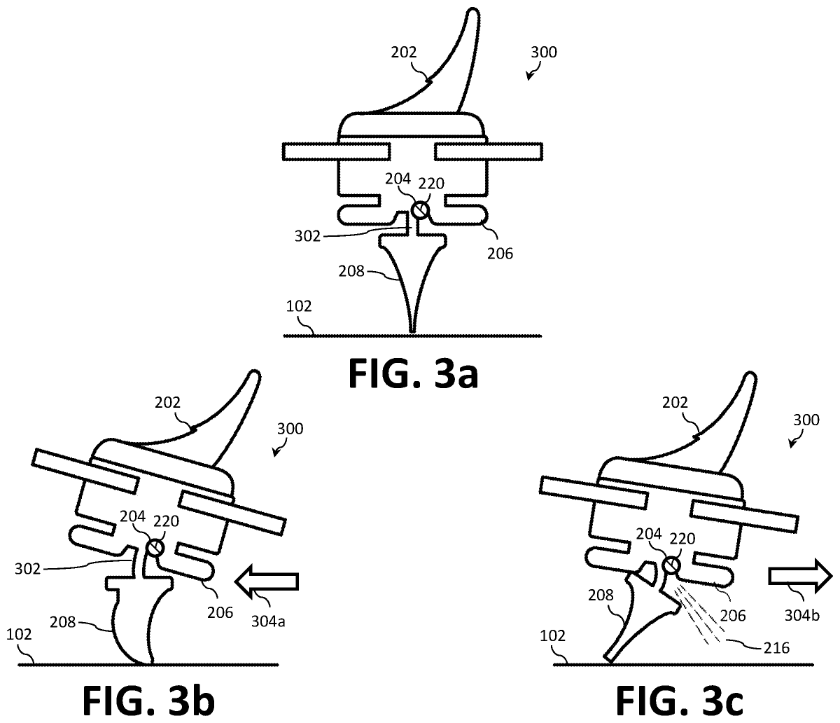

FIG. 3a though 3c illustrate a wiper blade 300 in accordance with another aspect of the present disclosure. Specifically, FIG. 3a illustrates the wiper blade 300 is a static state, while FIGS. 3b and 3c illustrate the wiper blade 300 translating across a windshield 102 in, respectively, a first direction 304a and a second direction 304b that is opposite that of the first direction 304a. As is known in the art, each cycle includes a translation of the wiper blade 300 across the windshield 102 in the first direction 304a and then back in the second direction 304b.

The wiper blade 300 of FIGS. 3a through 3c is substantially the same as the wiper blade 104 of FIGS. 2a and 2b except for the location and operation (e.g., control) of the dispensing ports 204 and associate valves 220. Whereas the dispensing ports 204 of FIGS. 2a and 2b are positioned on the sides of the wiper blade 104 at spoiler 202, they can be positioned on other surfaces. For example, the dispensing ports 204 of FIGS. 3a through 3c are positioned on the undersides of the spoiler 202, at or adjacent the connection point between the wiping lip 208 and the squeegee 206.

The valve 220 of the dispensing ports 204 can be opened and closed using the position of the wiping lip 208. That is, the valve 220 can be controlled as a function of a position of the wiping lip 208 as the wiper blade 300 translates across the windshield 102. As best illustrated in FIGS. 3b and 3c, during operation of the wiper blade 300, the wiping lip 208 flexes back and forth about a flexible pivot point 302 as the wiper blade 300 and wiping lip 208 travel in the first direction 304a and the second direction 304b.

As the wiping lip 208 flexes back and forth, the wiping lip 208 flexes the material at the flexible pivot point 302. The squeegee 206 can be shaped such that the material at or near the flexible pivot point 302 moves to effectively block and unblock the dispensing port 204. For example, when moving in the first direction 304a as illustrated in FIG. 3b, the wiping lip 208 is flexed in a direction toward the dispensing port 204 that, in effect, pinches the dispensing port 204 closed. Conversely, when moving in the second direction 304b as illustrated in FIG. 3c, the wiping lip 208 is flexed in a direction away from the dispensing port 204 that, in effect, releases the dispensing port 204 to fluidly open the dispensing port 204. In this example, the valve 220 can be, for example, a self-closing slit seal that is opened by movement of the wiping lip 208.

While a dispensing port 204 is illustrated on only one side of the wiping lip 208, dispensing ports 204 can be positioned on each side of the spoiler 202 to release an amount of chemical solution 216 in an alternating manner between sides of the wiping lip 208 as the wiper blade 300 travels in the first direction 304a and the second direction 304b.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A wiper blade for a windshield of a vehicle, the wiper blade comprising:
a spoiler, wherein the spoiler comprises a reservoir configured to hold a chemical solution;
a squeegee coupled to the spoiler, wherein the squeegee comprises a wiping lip; and
a plurality of dispensing ports distributed along a length of the wiper blade, wherein the plurality of dispensing ports is fluidly coupled to the reservoir and configured to dispense the chemical solution onto a surface of the windshield.

2. The wiper blade of claim 1, wherein the spoiler further comprises one or more filler ports fluidly coupled to the reservoir.

3. The wiper blade of claim 1, wherein the spoiler is removably coupled to the squeegee.

4. The wiper blade of claim 1, wherein the reservoir is configured to fluidly couple to a windshield washer system of the vehicle.

5. The wiper blade of claim 1, wherein each of the plurality of dispensing ports comprises a valve configured to control a release of the chemical solution therethrough.

6. The wiper blade of claim 5, wherein the valve is a pressure valve.

7. The wiper blade of claim 5, wherein the valve is a weighted valve.

8. The wiper blade of claim 5, wherein the valve is a check valve.

9. The wiper blade of claim 5, wherein the valve is controlled as a function of a position of the wiping lip as the wiper blade translates across the windshield in a first direction and a second direction that is opposite that of the first direction.

10. The wiper blade of claim 9, wherein the valve is open while in the first direction and is closed while in the second direction.

11. The wiper blade of claim 1, wherein the chemical solution comprises a wax.

12. The wiper blade of claim 1, wherein the chemical solution comprises a non-stick coating.

13. The wiper blade of claim 1, wherein the chemical solution comprises a water repellant.

14. A wiper blade for a windshield of a vehicle, the wiper blade comprising:
a spoiler having a reservoir configured to hold a chemical solution;
a squeegee coupled to the spoiler, wherein the squeegee comprises a wiping lip; and
a plurality of dispensing ports distributed along a length of the wiper blade,
wherein the plurality of dispensing ports is fluidly coupled to the reservoir and configured to dispense the chemical solution onto a surface of the windshield, and
wherein each of the plurality of dispensing ports comprises a valve configured to control a release of the chemical solution therethrough.

15. The wiper blade of claim 14, wherein the spoiler further comprises one or more filler ports fluidly coupled to the reservoir.

16. The wiper blade of claim 14, wherein the spoiler is removably coupled to the squeegee.

17. The wiper blade of claim 14, wherein the valve is a pressure valve, a weighted valve, or a check valve.

18. A wiper blade for a windshield of a vehicle, the wiper blade comprising:
a spoiler having a reservoir configured to hold a chemical solution;
a squeegee coupled to the spoiler, wherein the squeegee comprises a wiping lip; and
a plurality of dispensing ports distributed along a length of the wiper blade,
wherein the plurality of dispensing ports is fluidly coupled to the reservoir and configured to dispense the chemical solution onto a surface of the windshield, and
wherein each of the plurality of dispensing ports comprises a valve configured to control a release of the chemical solution as a function of a position of the wiping lip as the wiper blade translates across the windshield in a first direction and a second direction that is opposite that of the first direction.

19. The wiper blade of claim 18, wherein the valve is open while in the first direction and is closed while in the second direction.

20. The wiper blade of claim 18, wherein the valve is a pressure valve, a weighted valve, or a check valve.
